(19) United States
(12) Patent Application Publication
(10) Pub. No.: US 2010/0013462 A1
(43) Pub. Date: Jan. 21, 2010

(54) INSTRUMENT FOR AUTOMATION WITH SINGLE-HANDED OPERATION

(75) Inventors: Nicolai Fink, Aesch (DE); Thomas Hartmann, Vaihingen/Enz (DE); Holger Seguin, Betzingen (DE); Mathieu Weibel, Wittelsmeir (FR)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta GmbH + Co. KG, Gerlingen (DE)

(21) Appl. No.: 12/309,816

(22) PCT Filed: Jul. 16, 2007
(86) PCT No.: PCT/EP2007/057285

§ 371 Date: Jun. 22, 2009

(30) Foreign Application Priority Data
Aug. 4, 2006 (DE) 102006036908.4

(51) Int. Cl. G01B 7/30

(52) U.S. Cl. 324/207.2; 324/207.24; 324/207.25

(57) ABSTRACT

In a measuring device for automation technology with single-hand servicing, a housing closable with a lid is provided. Arranged at an edge of the lid is a movable ring element, which is mounted to be slightly shiftable parallel to the longitudinal axis of the lid and to be rotatable about the longitudinal axis of the lid. On the lid are sensors, which serve for registering rotary and linear movement of the ring element, via which a display unit is operated.

The invention relates to a measuring device for automation technology, with single-hand operation, as defined in the preamble of claim 1.

In automation technology, measuring devices are often applied for registering process variables, such as pressure, temperature, flow, e.g. flow rate, pH-value, etc. A large number of such measuring devices are available from the members of the firm, Endress+Hauser.

Conventional measuring devices with single-hand operation for automation technology are composed, as a rule, of an electronics housing, whose inner space is closable with a lid. Integrated in this lid is, most often, a cover glass, which enables viewing of a display/operation unit lying behind the cover glass. In order to protect the device electronics, the lid seals the inner space of the housing, so, that dirt, or water, cannot penetrate into the inner space.

The display/operation unit includes a plurality of keypads, which can be operated through the cover glass

Besides such keypads, also rotate-press switches are known for servicing of measuring devices. Through rotation of a rotate-press switch, the content of a display (e.g. LC display) can be changed, or selected. Problematic in the case of such rotate-press switches, however, is that they must have a very complicated construction, in order to assure a typical state of sealing in automation technology. Moreover, they consume a significant amount of space, so that they are, as a rule, not used for smaller devices.

Both rotate-press switches, as well as keypads, cannot be operated with protective gloves, so that they are not employed e.g. in the petro-field. If there is no rotate-press switch present, then its advantages of e.g., especially, quick operation are lost to the operator.

An object of the invention is, therefore, to provide a measuring device for automation technology with single-hand operation, which does not have the aforementioned disadvantages, yet assures, especially, a high quality protection for the device electronics and, moreover, permits operation with protective gloves.

This object is achieved by the features set forth in claim 1.

Advantageous further developments of the invention are set forth in the dependent claims.

An essential idea of the invention is to arrange at the edge of a lid of a measuring device a movable, ring element, which enables single-hand operation. The ring element is, in such case, arranged to be slightly shiftable relative to the longitudinal axis of the lid and rotatable about the longitudinal axis of the lid. Sensors are provided on the lid for registering rotary and linear movement of the ring element.

The figures of the drawing show as follows:

FIG. 1 exploded view of a conventional measuring device for automation technology;

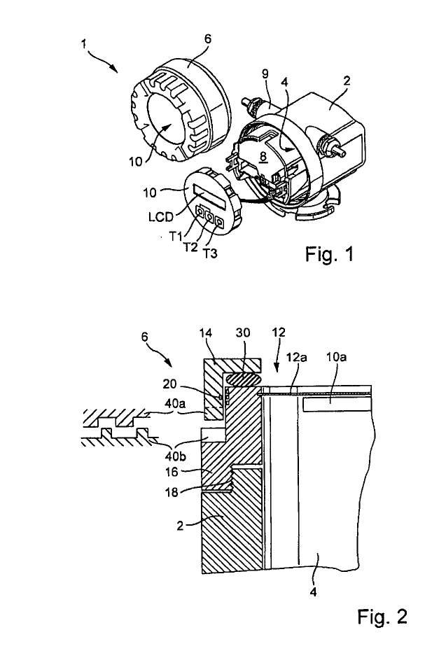

FIG. 2 sectional drawing in the lid region of a measuring device of the invention for automation technology; and

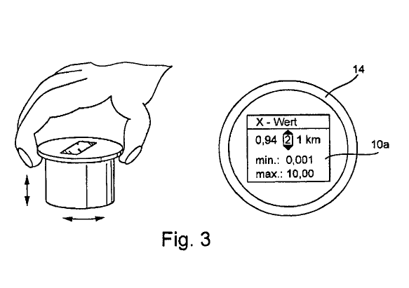

FIG. 3 plan view of a measuring device of the invention.

FIG. 1 shows a conventional measuring device for automation technology. The measuring device 1 includes, essentially, a housing 2, which serves for accommodating a device electronics 8. The device electronics 8 includes a display/operation unit 10 having three input keypads T1, T2, T3 and an LC display.

The inner space 4 of the housing 2 is closed with a lid 6. In order that the LC display and the keypads T1, T2, T3 are visible from the outside, the lid 6 includes a corresponding window 12. Lid 6 is affixed securely to the housing 2 by screwing. Serving for energy supply of the measuring device 1 is an auxiliary energy connection 7. The measurement signal registered by the measuring device can be forwarded via a signal connection 9, for example, to a control room.

FIG. 2 shows a detailing of the lid region of a measuring device of the invention. Corresponding parts have, in FIG. 2, the same reference characters as in FIG. 1.

The lid 6 is, in such case, provided in the form of two basic parts, the lid foundation 16 and a ring element 14. The ring element 14 is supported resiliently on the lid foundation 16 via a spring element 30.

The ring element 14 is mounted rotatably about the longitudinal axis L. It can also be shifted slightly in a direction parallel to the longitudinal axis, in order to provide a stroke movement.

Further shown in FIG. 2 is the screw thread 18, via which the lid foundation 16 can be screwed together with the housing 2. Sealing elements (not shown) are provided appropriately.

Arranged on the lid 6 are sensors 20, via which the rotational movement and the stroke movement of the ring element 14 can be registered. Corresponding connecting lines to the device electronics 8 are not shown, in order to avoid clutter in the drawing.

By pressing of the ring element 14 in the direction of the housing 2 with sufficient force, contact surfaces 40a, 40b come into engagement with one another. The construction of the contact surfaces 40a and 40b is such that that these enable force transfer between ring element 14 and lid foundation 16. In this way, the lid 6 can be rotated via the ring element 14, so that, for instance, the lid 6 can be removed from the housing 2 or screwed tightly thereto.

Behind a cover glass 12a, a display unit 10a is provided.

The operation of the invention will now be explained in greater detail. By rotation of the ring element 14, the content of the LC display LCD can be changed in accordance with a provided menu selection. Thus, for example, the units, with which a measured value should be presented in the display, can be changed. Selection of the units is confirmed by pressing the ring element 14, while de-selecting is accomplished by pulling the ring element 14.

FIG. 3 shows a plan view of a measuring device of the invention 1. Via the ring element 14, as shown, the third position from the decimal point of the indicated value 0.942 can be changed. In simple manner, a counterclockwise rotation means “up or minus”, a clockwise rotation “down or plus”, a pressing “enter or yes, selection in or open up”, a pulling “escape or no, terminate, back or close”.

FIG. 3 also shows, roughly, how single-hand operation is accomplished, when the housing basically does not exceed the size of a hand. In the case of larger housings, the ring element is gripped laterally.

In advantageous manner, the sensors 20 are Hall sensors or optical sensors.

In advantageous manner, ring element 14 and lid 6 can be frictionally engaged via the contact surfaces 40a, 40b, in order to enable an easy loosening, or tightening, of the lid 6 via the thread 18.

With the help of the measuring device of the invention for process automation technology, single-hand operation becomes possible even when somewhat cumbersome, protective gloves are being worn. In such case, a diameter of about 10 cm is suitable for the diameter of the ring element 14. With suitable corrugating of the edge of the ring element 14, such can be simply and reliably rotated, pressed or pulled, even when clumsy, protective gloves are being worn. A further advantage, which the invention offers, is that no mechanical feed-throughs lead into the inner space 4 of the measuring device. Because of this, the measuring device can be provided with the desired degree of sealing.

The ring element 14 enables, based on its construction, a relatively large window. Since keypads for the functions which the ring element takes over can now be omitted, the gained space can be used for a larger LC display.

### LIST OF REFERENCE CHARACTERS

TABLE 1

| | |
|---|---|
| longitudinal axis | L |
| rotary, and linear, movement | |
| measuring device | 1 |
| housing | 2 |
| inner space | 4 |
| lid | 6 |
| auxiliary energy connection | 7 |
| device electronics | 8 |
| signal connection | 9 |
| display/operation unit | 10 |
| display unit | 10a |
| window | 12 |
| cover glass | 12a |
| ring element | 14 |
| thread | 18 |
| sensors | 20 |
| spring element | 30 |
| contact surfaces | 40a, 40b |

1-8. (canceled)

9. A measuring device for automation technology with single-hand operation, comprising:
device electronics;
a lid; and
a housing with an inner space, which is closable with said lid and which serves for accommodating said device electronics, wherein:
said device electronics comprises a display unit, which is observable through a window provided in said lid;
there is arranged at an edge of said lid a movable ring element, which is mounted to be slightly shiftable parallel to the longitudinal axis of said lid and to be rotatable about the longitudinal axis of said lid; and
in that there are arranged on said lid sensors, which serve for registering rotary and linear movement of said ring element, via which said display unit is actuated.

10. The measuring device as claimed in claim 9, wherein:
said sensors comprise Hall sensors.

11. The measuring device as claimed in claim 9, wherein:
said sensors comprise optical sensors.

12. The measuring device as claimed in claim 10,
said window is formed by a cover glass.

13. The measuring device as claimed in claim 9, wherein:
said lid and said housing are axially affixed via a threaded connection.

14. The measuring device as claimed in claim 9, wherein:
said lid sealedly closes said inner space against incursion of water, dust, and gas.

15. The measuring device as claimed in claim 9, wherein:
said ring element and said lid have contact surfaces, which can be frictionally engaged for opening and closing said lid.

16. The measuring device as claimed in claim 9, wherein:
there is provided between said lid and said ring element a spring element, which prevents permanent engagement of the contact surfaces.
